(19) United States
(12) Patent Application Publication
(10) Pub. No.: US 2022/0164398 A1
(43) Pub. Date: May 26, 2022

(54) METHOD AND SYSTEM FOR ORDINARY USERS TO MODERATE INFORMATION

(71) Applicant: Aleksey Sergeevich Sokolov, Vladivostok (RU)

(72) Inventor: Aleksey Sergeevich Sokolov, Vladivostok (RU)

(21) Appl. No.: 17/441,302

(22) PCT Filed: Mar. 6, 2020
(86) PCT No.: PCT/RU2020/050041

§ 371 Date: Sep. 21, 2021

(30) Foreign Application Priority Data
Apr. 2, 2019 (RU) 2019109564

(51) Int. Cl. G06F 16/951; G06F 21/62; G06N 5/02

(52) U.S. Cl. CPC G06F 16/951; G06N 5/025; G06F 21/6218

(57) ABSTRACT

A method and system that allows ordinary users to moderate information in a computer system under conditions in which their evaluations can be trusted.

### FIELD OF THE INVENTION

The invention relates to the field of communication and can be used in computer systems of user content to control compliance with the rules applied to the information entered into the system.

### BACKGROUND OF THE INVENTION

Nowadays, computer systems are widespread on the Internet that accumulate information from many users. For example, systems such as web directories, thematic portals, community pages, commenting systems, micro-blogging, a search engines accumulate information received from users, and also allow their users to edit information online. But often users violate the rules established on this kind Internet sites. As a result, site administrators are faced with the need to identify information that does not comply with the rules. The main solution to maintain order is to involve a moderator—a specially appointed user trusted by the system administrator and other users to monitor compliance with the rules established for the information. Moderators around the world check a huge amount of information on various sites every day. At the same time, the amount of information created by users in the systems is constantly increasing due to the availability of the Internet to more and more people, which leads to a constant increase in the burden on moderators. In this regard, there is an unmet need to develop ways to moderate information aimed at reducing the burden on moderators.

“Information” in the claimed invention is meant as a data any way entered and stored in a computer system. “Moderation” in the claimed invention is meant as a evaluation of the information compliance with predetermined rules. “User” of the system in the claimed invention may be any person who uses the system to input or output the information. Some users may have access to functions to customize the system, such users are meant as “administrators” of the system. “Ordinary user” in the claimed invention is meant as a user who has no access to the system configuration functions.

There is a known method of automatic moderation of messages (RU2670029, cl. G06F17/21, G06F17/27, GO6Q10/10, Bulletin 29, 2018), which is a system that evaluates the presence of inappropriate words in messages. However, despite the ability of automated methods to detect messages with profanity, at the moment the automated tools have problems with understanding the meaning of the separate block of information. For example, automated tools have difficulty detecting violations related to off-topic posts, spam posts, and posts related to trolling other users. These difficulties mean that the moderating process using automatic prior art tools still requires the supervision of a moderator.

A system (US No. 20140156748A1, cl. G06Q10/10, 2014) is also known in which the acceptability of an individual message is evaluated by a jury consisting of ordinary users selected at random. However, this type prior art user moderation using a jury also has certain disadvantages. In particular, the moderation implies a lack of trust in the integrity of the assessment made by an ordinary user and, as a consequence, the need to organize a collective vote to make a decision on each individual message. At the same time, a sufficient number of voting users may simply not be available to organize such a vote.

The closest to the claimed technical solution is a method (WO2008091675, cl. G06F 17/30, G06F 21/36, 2008) for accessing computer systems, known as reCAPCHA, taken as a prototype. The method is a computer test used to determine whether a user of the system is a human or a computer program. The method involves creating a task for the user. The task contains an unknown part, for which the system does not know the answer, and a known part, for which the system knows the answer. The user is prompted to solve the unknown and the known parts of the task. After receiving input from the user, the system determines that the user's input in the known part of the task matches to the answer known to the system for the known parts of the task. And also the user input in the unknown part of the task is identified as the answer to the unknown part of the task, if the user input in the known part of the task matches to the answer known to the system for the known part of the task;

For example, in one embodiment of reCAPCHA, the user, in order to access the site, is prompted to look at two pictures, each with one word on it, and to enter the words matching to these pictures into the system. The word from one picture is already known to the system and is a check word. The word from the second picture is not known to the system, and the picture itself cannot be recognized by modern computer programs. At the same time the user does not know which picture's word is already known to the system and which is not, that makes the user try to enter the correct words for both pictures to gain access to the system. According to the prototype, if the user enters the correct check word for a picture known to the system, the system lets the user continue. In addition, the word entered by the user for a picture unknown to the system is stored in the system and is considered a possible variant of recognition.

The advantage of the method is that the method allows to direct the efforts of ordinary users, which they spend in the process of getting access to the system, to perform socially useful work. And besides the method creates conditions, in which it is possible to trust the results of the performance of this work. Efficiency and working capacity of such a method was proved by practical application. So, with this option of protecting Web sites from Internet bots only for the first 6 months of use users have successfully recognized about 150 million words, not recognized by automatic recognition means, which is the equivalent of 7500 books.

However, the main disadvantage of the prototype is that it does not provide any solution that allows ordinary users to identify information that does not comply with the rules of the system, due to the fact that the prototype was designed as a method of controlling access to the computer system by people and programs.

The lack of this solution in the prototype does not allow ordinary users to do the useful work of moderating information in the computer system on their own, under conditions in which their evaluations can be trusted, which makes it impossible to use the prototype to reduce the burden on moderators. Also, the lack of this solution in the prototype does not allow the prototype to be used in cases where the automatic means lack the ability to detect information that violates the rules.

The claimed invention aims to extend the methods and systems of user stand-alone control of compliance with the rules applied to the information entered into the computer system and focused at reducing the burden on moderators.

The technical result of the invention is the creation of a method and system that allows ordinary users to moderate information in a computer system and that provides conditions under which the evaluations of ordinary users can be trusted. Using claimed method of moderation of information, we can build systems in which the ordinary users have a tool to independently control the information for compliance with the rules. This kind of user moderation in a system can be useful either by itself or as an addition to existing methods of information verification. The invention can be used to reduce the burden on moderators, in situations where moderators cannot keep up with the increasing volume of information or where there is a problem with assigning a moderator. This kind of user moderation can also be useful when automated tools lack the ability to identify information that violates the rules. For example, inappropriate information often appears in search engine results. Using the claimed invention, users can independently remove information that is undesirable in search results.

### BRIEF SUMMARY OF THE INVENTION

To achieve the aim of the claimed invention, a method for moderation of information by ordinary users is proposed. The method, which includes creating a task for an ordinary user of a computer system, which contains at least one known part for which the system knows the answer and at least one unknown part for which the system does not know the answer; requesting that the user solve the known and unknown parts of the task; receiving answers from the user; determining that the user's answers in the known parts of the task match to the answers known to the system for the known parts of the task; identifying the user's answers in the unknown parts of the task as a solution for the unknown parts of the task if the user's answers in the known parts of the task match to answers that are known to the system for the known parts of the task;

The claimed method differs from the prototype in that the known and unknown parts of the task contain an offer to the user to evaluate the information for compliance with rules.

An embodiment of the claimed method is possible, in which before a task is created for the user, the system administrator performs system configuration, which includes: creation of rules applied to the information; creation of known information that does not comply with the rules; creation of known information that complies with the rules.

An embodiment of the claimed method is possible, in which the user is offered to perform the task before being permitted to enter information into the system.

An embodiment of the claimed method is possible, in which to create a separate part of the task is performed: sampling of known information or sampling of unknown information, marked as needing to be evaluated for compliance with the rules; creating an offer to the user to evaluate this information.

An embodiment of the claimed method is possible, in which the task includes at least one known part in which the rules are violated and at least one known part in which the rules are not violated.

An embodiment of the claimed method is possible, in which the user is offered to evaluate the unknown and known parts of the task without informing the user which of the parts are the unknown parts of the task, and which of the parts are the known parts of the task.

An embodiment of the claimed method is possible, in which the user is permitted to enter information into the system if the user's evaluation of at least one known part of the task matches to the evaluation that is known to the system for that known part of the task.

An embodiment of the claimed method is possible, in which after the user is permitted to enter information into the system, information is received from the user and the information entered by the user is marked as needing to be evaluated for compliance with the rules.

An embodiment of the claimed method is possible, in which the information needing evaluation may contain text, pictures, links, audio recordings, video recordings.

An embodiment of the claimed method is possible, in which the user evaluation in the unknown part of the task is identified as a decision about compliance of the information from the unknown part of the task with the rules, if all user evaluations in the known parts of the task match to the evaluations, which are known to the system, for the known parts of the task.

An embodiment of the claimed method is possible, in which after identifying the user evaluation in the unknown part of the task, as a decision about compliance with the rules, the information from the unknown part of the task is marked as evaluated information or the information from the unknown part of the task is marked as known information.

In another aspect of the invention, to achieve the aim of the claimed invention, a system for moderation of information by ordinary users is proposed. The system includes a network of multiple devices in which at least one of the devices is used by the ordinary user to input information into the system; at least one of the devices includes a processor and memory, characterized in that, the memory contains machine-readable commands which, when executed by the processor, cause the processor to perform operations in accordance with any embodiment of the above claimed method of information moderation by ordinary users.

### BRIEF DESCRIPTION OF THE SEVERAL VIEWS OF THE DRAWING

The essence of the claimed invention is explained by the drawings, where

FIG. 1 shows one embodiment of a computer system that allows ordinary users to moderate information,

FIG. 2 shows one embodiment of the system setup,

FIG. 3 shows one embodiment of the method,

FIG. 4 shows one embodiment of creating a separate part of a task offered to the ordinary user for evaluation,

FIG. 5 shows one embodiment of the present invention in which the ordinary user is permitted to enter information into the system,

FIG. 6 shows one embodiment of the invention in which an evaluation of information received from the ordinary user in an unknown part of a task is used to decide whether that information complies with the rules,

FIG. 7 shows an example of an offer to the ordinary user to perform a task,

FIG. 8 shows an example of an offer to an ordinary user to evaluate information,

FIG. 9 shows one embodiment of a computer system in which the separate steps of the presented moderation method are centrally performed.

### DETAILED DESCRIPTION OF THE INVENTION

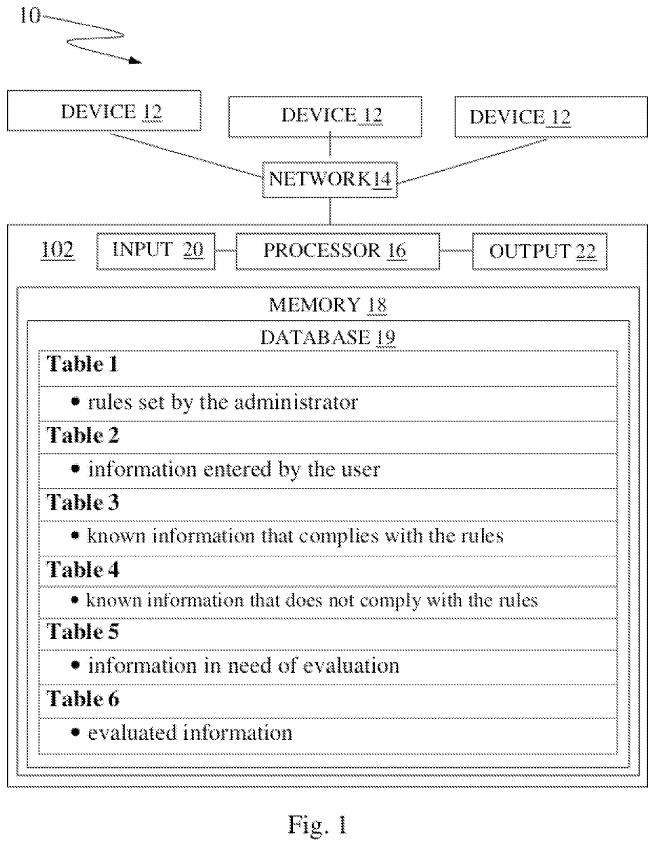

The following is a detailed description of the embodiments illustrated in the attached drawings. The following description is illustrative only and is not intended to impose any limitations. The embodiment of the invention is described in terms of the moderation of information entered by users into the computer system shown in FIG. 1.

FIG. 1 illustrates one embodiment of a computer system 10 that allows ordinary users to moderate information. The computer system 10 may include a variety of personal electronic devices 12 such as cell phones, desktop computers, laptops, terminals, etc. The devices 12 are connected to a network 14, such as the Internet, via a wired or wireless connection. One or more of the devices 12 of the computer system 10 is a server 102 operating on the network 14 that provides users with the ability to input, store, process, and output information in various forms and through various standard forms of input. For example, the server 102 may be a web directory, a theme portal, a server storing map information, community pages, systems commenting, micro-blogging, a search engine, or any other system that is filled with information via the web 14. The user may use one of the devices 12 which may include a standard web browser or any other application that allows input and output from the user device 12 to/from the server 102 via the network 14. The administrator may configure the computer system 10 by making settings on the server 102. The server 102 may include one or more processors 16, memory 18, input devices 20, and output devices 22. The processor 16 may execute various machine-readable commands, such as software, firmware, and hardware. The input device 20 can be any form of information input, including those operating over a network 14, that allows machine-readable commands to be transmitted to the processor 16. For example, the input device may be a keyboard, touch screen, computer mouse, microphone, or any other form of user input, whether located on the user device 12 or on the server 102 itself. The output device 22 may be any form of output to the user from the processor 16, including those operating through the network 14. For example, it may be a video display, a speaker, a touch screen, or any other form of user information output located on both the user device 12 and the server 102 itself.

Memory 18 can be any form of computer-readable memory embodied in any form of machine-readable media. For example, memory 18 may store information in magnetic form, electronic form, optical form. The memory 18 may also contain one or more databases 19 that store logically linked information recorded in a structured form in order to enable efficient retrieval and processing. The database 19 may contain spreadsheets, each of which is a logical data structure that stores a set of identical information. In the presented embodiment of the computer system 10, the database 19 contains tables 1-6 used to be used to implement a method of moderation of information by ordinary users.

The memory 18 of computer system 10, as described above, includes machine-readable commands that, when executed by the processor 16, cause the processor 16 to perform operations in accordance with any of the implementation of the claimed method of moderation of information by ordinary users.

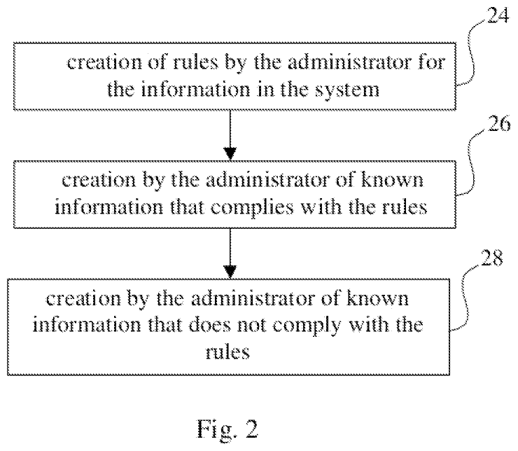

FIG. 2 shows one embodiment of a configuration of the computer system 10, that is performed by the system administrator prior to step 30, in which a task is created for the ordinary user of the computer system 10.

In step 24, the administrator of the computer system 10 creates rules for the information. In this step, the administrator creates rules that must be satisfied by the information entered into the system, and places the rules into the system into the table 1 using standard database tools. There may be many variations of the rules created by the system administrator at this stage, depending on the wishes of the computer system administrator 10. For example, an administrator in a commenting system might define rules that user-entered comments should not contain any insult to other users, and should also be consistent with the topic that users are commenting on. Or, for example, a bulletin board administrator may specify a requirement that user-entered ads must not contain any contact information, and must also be appropriate for the category in which they are posted.

One possible example of rules 84 developed by an administrator in a commenting system is shown on FIG. 8. The rules devised by the system administrator are placed electronically in a database 19 in table 1, which is created and filled by the system administrator 10 using standard database tools.

In step 26, the system administrator 10 creates known information that matches the rules. In this step, the administrator prepares the information that matches the rules and places it into the database 19 into the table 3, which is designed for the known information that matches the rules. Various implementations of step 26 are possible. In one embodiment, the administrator may manually select the rule-matching information among the information previously entered by the ordinary users in step 50. The selected information, the administrator may transfer to the database 19 table 3 by known standard database tools. For example, an administrator of a bulletin board may first select advertisements matching the rules among the advertisements previously added by ordinary users. And then the administrator can transfer those advertisements to table 3 using known standard database tools. In another possible embodiment of the claimed method, the rule-matching information may be manually added to table 3 by the administrator using known standard database tools. For example, an administrator in a commenting system may manually enter individual comments and/or sets of comments matching the rules into table 3 as known comments.

In step 28, the system administrator 10 creates known information that does not comply with the rules. In this step, the administrator prepares the information that does not match the rules and places it into the database 19 into the table 4, which is designed for the known information that does not match the rules. Various implementations of step 28 are possible. In one embodiment, the administrator may manually select the non-compliant information among the information previously entered by the ordinary users in step 50. The selected information, the administrator may transfer to the table 4 of the database 19 by known standard database tools. For example, an administrator of a bulletin board may first select advertisements that do not match the rules among advertisements already added by ordinary users. The administrator may then move those advertisements to table 4 using known standard database tools. In another possible embodiment of the claimed method, non-compliant information may be manually added to table 4 by an administrator using known standard database tools. For example, an administrator in a commenting system may manually enter individual comments and/or sets of comments that do not comply with the rules into table 4 as known comments.

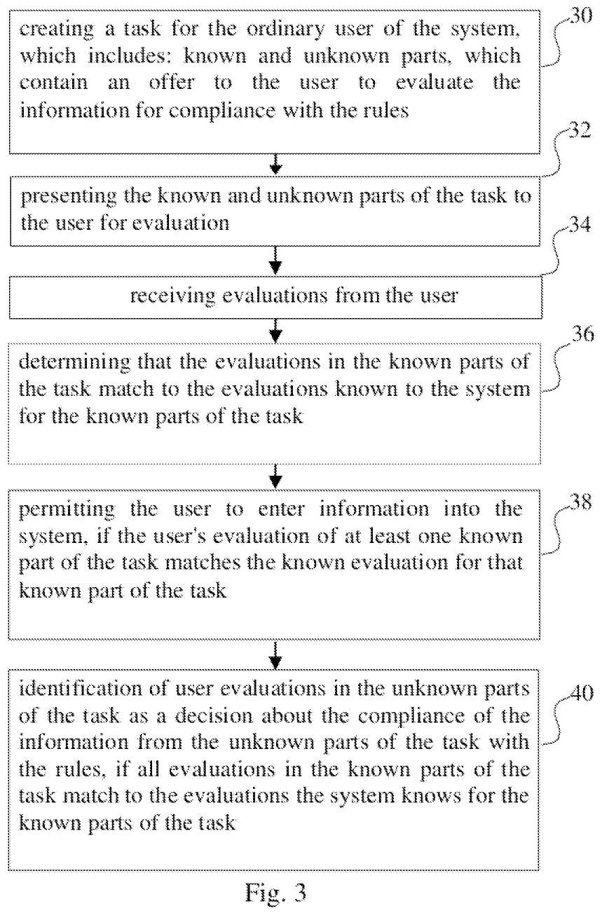

FIG. 3 shows a flowchart illustrating one embodiment of a method that can be implemented in machine-readable instructions stored in one or more memory devices 18 and executed by one or more processors 16 of server 102.

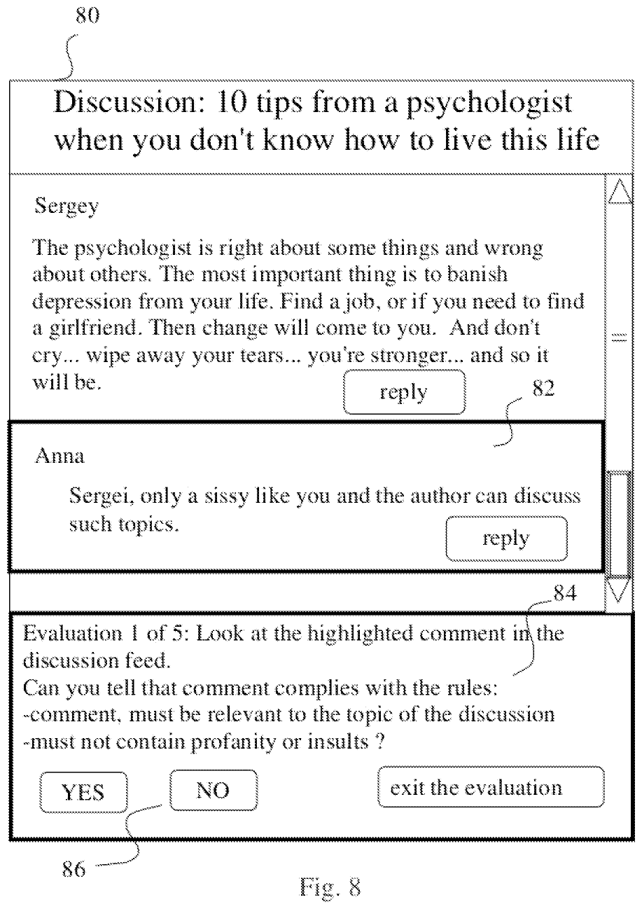

Step 30 includes creating a task for the ordinary user of the computer system 10. The creation of the task is performed prior to the user receiving permission to input information into the computer system 10. The task may be offered to the user of the computer system 10 while the user is accessing various functions of the computer system 10. For example, creating the task is performed before permitting a user to add or edit information on server 102: an article, comment, advertisement, etc. So, for example, in a commenting system, a user who wants to submit a comment that violates the rules of the system will first be asked to perform the task. Or, for example, on a bulletin board, a task might be offered to a user who wants to add an advertisement. An example of an offer 76 to the user to perform a task, appearing after the user has pressed the button 72, is shown in FIG. 7.

The created task consists of a set of parts that include requesting that the user evaluate the information for compliance with rules that are defined by the system administrator in step 24 of setting up the computer system 10. A separate part of the task may be a visual evaluation offer, in which the user is prompted to look at an image on a screen and make an evaluation. Although the claimed method is generally described in terms of visual evaluation offers, the method is not limited to the use of evaluation offers that are visual. For example, in other embodiments of the invention, a separate part of the task may be an audio task in which the user is asked to listen to an audio recording and make an evaluation. It is also possible to implement the method using evaluation offers other than visual or audio. For example, it may be tactile offers similar to Braille and/or evaluation offers related to smell and taste.

Some parts of the task are known parts for which compliance with the rules is already known to system 10, and other parts are unknown parts for which the evaluation of rule compliance is not known to system 10.

The known parts include known information previously created by the system administrator in steps 26 and 28 of system configuration. It is also possible that the known parts of the task include information from ordinary users, marked as known information in step 62.

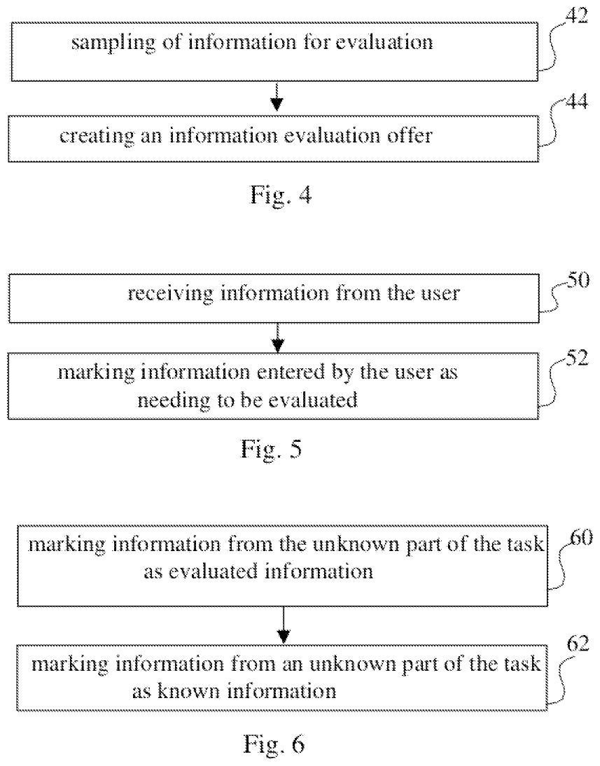

The unknown parts of the task include information that needs to be evaluated for rule compliance. Such information may have been entered into the computer system 10 earlier, by any ordinary users of the system at step 50, and thereafter marked at step 52 as needing evaluation. It is also possible that when there is no information in the system 10 that needs to be evaluated for rule compliance, the unknown parts include the known information previously created by the system administrator in steps 26 and 28 of system setup. It is also possible that when there is no information in the system 10 that needs to be evaluated for compliance with the rules, the unknown parts of the task include information from ordinary users marked at step 60 as already evaluated information. One embodiment of creating a separate part of a task containing an offer to the user to evaluate the compliance of the information with the rules is illustrated in more detail in FIG. 4.

Different numbers of both unknown and known parts of the task are possible. The minimum task conditions assume one known part and one unknown part. It is believed that this minimum number of parts of the task is sufficient to acquaint the user with the rules for the information entered into the system, and to acquaint the user with the mechanism for checking the information for compliance with the rules Familiarizing users with the rules and the information checking mechanism is an important part of the method Familiarizing the user with the rules, while he is performing his task, helps to convey to the user that it is better for him to try to honestly use the rules developed by the administrator of computer system 10 than to try to guess which part of the task is known to the system and which part of the task is not known to the system. It is expected that familiarizing users with the rules and the checking mechanism will reduce the amount of information entered into the system that does not comply with the rules.

It is also assumed that the optimal conditions for a user to perform the task involve at least one known part of the task in which the information complies to the rules determined by the system administrator 10 in the system setup step 24, and at least one unknown part in which the information does not complies to the rules. It is assumed that increasing the number of known parts of the task, results in an increase in the accuracy of the response in the unknown part of the task, and also results in an increase in the difficulty of accessing the input functions of computer system 10. It is also assumed that an increase in the number of unknown parts, results in an increase in the amount of useful work done by the user, but also results in an increase in the difficulty of the user accessing the input functions of computer system 10.

Step 32 consists of presenting the known and unknown parts of the task to the user for evaluation. The presentation of the known and unknown parts to the user may be a visual task displayed to the user on a monitor, but the known and unknown parts may also be displayed on another output device: for example, they may be output through a speaker. In the process of presenting parts of the task to the user of the system for evaluation, the user should not be informed in any way which parts of the task are known and which are unknown. It is believed that the best results will be achieved if the known and unknown parts of the task are implemented in the same style, for example, in a font of the same or similar size, although this is not a prerequisite for the claimed method.

In one embodiment of the method, the parts of the task prepared in step 30 can be mixed in a random order, for example using any known standard random sorting algorithm. Various alternatives of the order in which the known and unknown parts of the task are presented to the user for evaluation are possible. The parts of the task may be presented to the user for evaluation simultaneously or at different times. In one embodiment, the known and unknown parts of the task may be presented to the user for evaluation one after the other. In another embodiment of the method, the parts of the task may be presented to the user for evaluation simultaneously.

Step 34 includes receiving an evaluation from the user. This evaluation, entered by the user through the input device 20, is the user's answer to the part of the task offered to the user. The evaluation may be entered into the system 10 in various forms depending on the nature of the input device 20. So, for example, if the user enters a response from the keyboard, the response from the user is likely to be in the form of ASCII characters in electronic form. Acceptance of the user's evaluation for each part of the task may occur either simultaneously or sequentially, depending on the order in which the user is presented with the known and unknown parts of the task in step 32.

Step 36 includes determining whether the user evaluations in the known parts of the task match the evaluations that are known to the computer system 10 for the known parts of the task. This step can be implemented in several ways. For example, the matching determination may be performed locally on the user device 12 by comparing the user's evaluations with the evaluations known to the computer system 10. In another possible embodiment, evaluations from the user may be sent to a server 102 on the network 14, where these evaluations from the user are compared to evaluations for known parts of the task stored in the database 19, and after comparison from the server 102, a matching result is returned to the user device 12. Determining whether user evaluations for known parts of a task match known system evaluations for known parts of a task may occur either simultaneously, after all user evaluations are received, or sequentially, each time an individual user evaluation is received. The matching determination can be calculated either on the basis of all the user evaluations in the known parts of the task or on the basis of a selective subset of evaluations.

Step 38 includes permitting a user to enter information into the system if the user's evaluation of at least one known part of the task matches the known evaluation for that known part of the task. In other words, in this step, the user may be given the opportunity to enter information into the system 10, even if it is determined that not all of the user's evaluations match the known evaluations for the known parts. But, in such a case, due to the user's admitted inconsistencies, the user's evaluation of the information in the unknown part will not be accepted in step 40. In step 38, the user may access various information input functions in the system. For example, in the commenting system, the user may be given access to a form for adding a comment. Or, in the case of a user operating an advertisement site, the user may be given access to a form for adding an advertisement.

To permit a user to input information into the system in such a simplified manner, as opposed to the prototype, without requiring that all user evaluations in known parts must match evaluations that are known to the system, is due to the fact that the claimed method is not intended to determine whether the system user is a human or a program. On the contrary, it is assumed that the method is used only by humans, and it is assumed that, in order to protect the system 10 from programs, specifically designed mechanisms controlling access to the system, for example, such as the reCAPCHA mechanism, will be used before the use of the claimed method. As shown in step 32, efforts are made to prevent the user from guessing which parts of the task are known and which parts of the task are unknown. As a result, it is easier for the human user, as opposed to the program, to try to honestly solve all parts of the task rather than trying to guess which parts are known. It is assumed that simplified access to the system is enough to forcibly familiarize the human-user with the rules and with the mechanism of checking the entered information for compliance with these rules.

Step 40 includes identifying the user evaluation in the unknown part of the task as a decision about compliance the information from the unknown part of the task with the rules, if the user evaluations in all known parts of the task match the evaluations that are known to the system 10, for the known parts of the task. Namely, if all user evaluations in known parts of the task match the evaluations that are known to system 10 for known parts of the task, then it is assumed that the user understands the rules and tries to apply them in general and, accordingly, also tries to apply the rules in the evaluation in the unknown part of the task as well.

A user evaluation for information in an unknown part of a task may be accepted as a final evaluation or as a potential evaluation. According to the claimed invention, information that needs to be evaluated for compliance with the rules may be presented to users of system 10 for evaluation in unknown parts more than once. In this case, the evaluations of this information received from different users in the unknown parts of the task may be compared in order to determine the most accurate final evaluation of this information by collective voting. For example, in some embodiments of the method, the same information may be shown in unknown parts to at least three users, and the final decision as to whether that information matches to the rules will be determined by the most consensus assessment.

In addition, according to the invention, an evaluation of information in an unknown part of a task can be accepted as a final evaluation even without organizing a collective vote, from just one user, under the condition of increasing the number of known parts, and under the condition that user evaluations in all known parts match the evaluations that system known. It is assumed that the matching of the user's evaluations with the evaluations that system's known in all known parts when the number of known parts increases indicates a decrease in the probability of the user passing the task at random. Also, the matching of the evaluations in all known parts with the increase in the number of known parts shows that the user understands and uses the rules, which in turn leads to an increase in the accuracy of the evaluation in the unknown part of the task as well. For example, it is possible a variant of a task in which the task contains only one unknown part and two known parts. In that case for the user's evaluation in the unknown part to be considered as final, it can be sufficient that the user's evaluations in the known parts match the system's known evaluations for these two known parts of the task.

FIG. 4 illustrates one embodiment of creating a separate part of the task containing an offer to the ordinary user to evaluate compliance of the information with the rules set by the system administrator on step 24. The steps 42 and 44 shown in the flowchart are used in step 30 during the creation of the separate part of the task.

In step 42, the information is sampled to create a separate part of the task. There are several variants of information sampling at step 42, depending on whether the part of the task is known or unknown. In one case, in order to create a known part of the task that does not match the rules, from table 4, which stores the electronic representation of the information that does not match the rules, a random sampling is performed using any random selection algorithm known in the prior art.

In another case, to create a known part of the task matching the rules, from table 3, where the electronic representation of the information that matches the rules is stored, a random sampling is performed using any random sampling algorithm known in the prior art.

In the third case, in order to create the unknown part of the task, a random sampling is performed from table 5, where the information marked in step 52 as needing evaluation is stored, using any random sampling algorithm known in the prior art. It is also possible to select the information to create the unknown part of the task from table 5 in a non-random manner. For example, it is possible to select according to the FIFO principle (first in-first out). In some cases, the user may receive for evaluation the information previously entered in the system by it himself. This should not be a problem, because the user does not know whether his information has already been evaluated and whether his information is not used as known, according to step 62. In addition, standard technical metrics that are known in the prior art and used to identify the uniqueness of the devices 12 in the network 14 can also be used to reduce the likelihood of the user getting for evaluation the information previously entered into the system by him/herself. For example, metrics such as the IP address of the user device 12 on the network 14, the version of the operating system and web browser on the user device 12, the screen resolution on the user device 12, the presence of software components on the user device 12, or a combination of these metrics may be used.

It is also possible that if there is no information in system 10 in table 5 that needs to be evaluated for rule compliance, information from tables 2, 3, 6, selected at random, using any random sampling algorithm known in the prior art, can be included in the unknown parts of the test.

In step 44, an offer to the user to evaluate the information is created. The information in need of evaluation may be a block of information that includes text, pictures, web links, audio recordings, video recordings, or any combination thereof. The evaluation offer itself may take a variety of forms. For example, in one embodiment of the method, the user is presented with a block of information along with the rules that were determined by the system administrator 10 in step 24, and a question implying a “yes” or “no” response as to whether that block of information conforms to the rules presented. A variation of the offer 86 to the user is presented in FIG. 8, where the user is presented with a highlighted comment 82 and the rules 84 that the comments in the system must satisfy. Alternatively, the user may be presented with multiple blocks of information and one of the rules defined by the system administrator 10 in step 24, and the user is prompted to select the block of information that most matches that rule.

FIG. 5 illustrates one embodiment of how an ordinary user inputs information into the computer system 10. Step 50 is a receipt of an electronic representation of the information, depending on the type of input device 20 that the user uses. For example, it may be an electronic representation of characters, an electronic representation of audio data, or an electronic representation of video data. For example, if the user enters information from the keyboard, the information is likely to be represented as ASCII character codes. The electronic representation of the information is saved in Table 2 in database 19 of System 102 using standard database tools.

In one embodiment of the method, the information entered by the user may not be immediately available to other users until the information has been evaluated for rule matching. In another possible embodiment of the method, in contrast, the entered information may be available to all users of the computer system 10 immediately after receiving that information from the user. However, the visibility of this information to other users of the system 10 may change at a later time, after the information has been evaluated and found not to comply with the rules as determined by the administrator of the computer system 10. The claimed method assumes that the information entered into the system by the user may contain electronic representations of text, pictures, links, audio recordings, video recordings. Also, the invention contemplates that the user can not to enter information, but simply send information already in the system to be rechecked against the rules. An example of the situation is shown in FIG. 7, where the user can click on button 72 to send an abusive comment already posted to the system for rule-checking.

Step 52 is a marking of the information entered by the user in step 50 as needing to be evaluated. This marking is used in step 42 to determine which information needs to be evaluated and which information has already been evaluated. In one embodiment of the claimed method, the marking may be an operation of transferring the information, from table 2 to table 5, which stores the information to be evaluated, using known standard database tools.

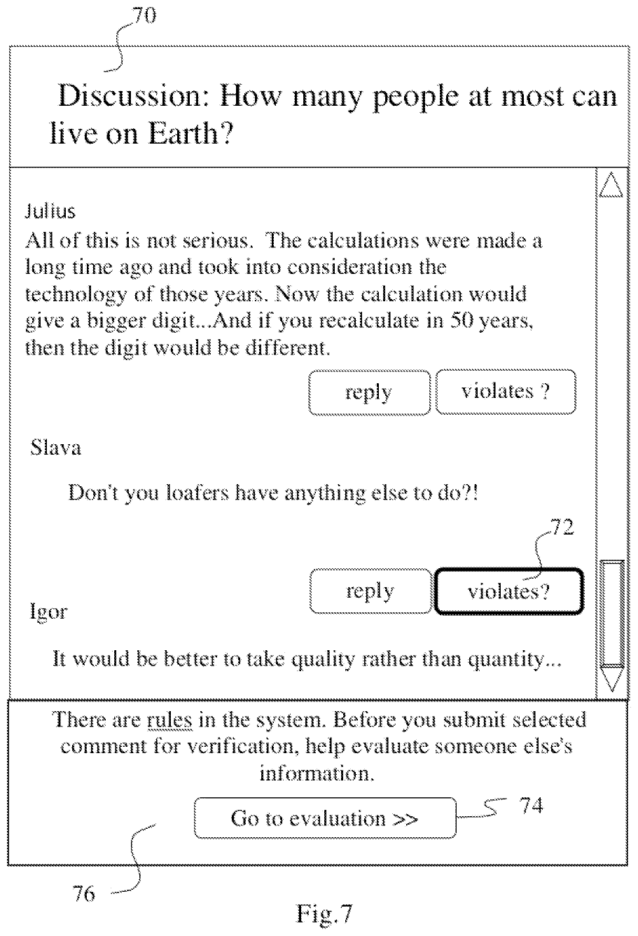

FIG. 6 illustrates one embodiment of the invention in which an evaluation of information received from the ordinary user in an unknown part of a task is used to decide whether that information complies with the rules. Namely, when a final evaluation is received from the user in step 40 about the matching of the information to the rules, based on this final evaluation, further actions with the information can be performed by the system.

In Step 60 the information from the unknown part of the task is marked as already evaluated information. This marking can be implemented in various ways. In one embodiment of the claimed method, marking may be the operation of transferring the information that needs to be evaluated from table 5 to table 6, which stores the evaluated information, by known standard means of working with databases. When the information that needs to be evaluated is marked as evaluated, the information may change availability to users of the system. For example, a comment in the commenting system whose evaluation is found to be inappropriate may, after marking, be hidden from users. Or vice versa, information whose evaluation is found to be compliant with the rules may become visible to users. For example, an advertisement on an advertisement site may become visible to users if the evaluation of the advertisement has been found to match the rules defined by the administrator of the advertisement site.

Step 62 is the marking of information from an unknown part of a task as known information, matching or not matching the rules set by the administrator. In this case, the marked information can then be used in the known parts of the task. The marking can be performed in various ways. In one embodiment of the claimed method, the marking can be an operation of transferring, depending on the evaluation received from the user, from the table 5 storing the information needing evaluation to the table 3 or table 4 storing the known information, using standard database tools.

FIG. 7 shows an example of an offer to the user to perform a task. Form 70 includes a comment feed. In this case, near each comment, besides the standard “reply” button on the comment, there is a “violates” button. FIG. 7 shows a comment from the user “Slava” insulting other users. Any user can send this comment to be checked for compliance with the rules set by the administrator by clicking on button 72. The user will then be displayed a form 76 that invites the user to do useful work by going through the task. When the user clicks on the button 74, the task will be created and offered to the user, for example, as shown in FIG. 8. Once the user has evaluated all parts of the task, and his evaluation in at least one known part of the task matches the evaluation that is known to the system, then according to step 38, the user will be permitted to enter information into the system. In this case, after that, the system will mark the comment from the user “Slava” as needing evaluation, and this comment will be offered to other users for further evaluation.

FIG. 8 illustrates an example of an offer to a user to evaluate information, and shows part 1 of a 5-part task. The form 80 includes a comment feed with a highlighted comment 82 and a offer to user to evaluate the highlighted comment for compliance with rules 84 that have been set by the system administrator. The user must perform the evaluation by clicking on one of the selection 86 buttons. When the user makes a choice, another comment feed will be shown to the user and the user will be invited to evaluate another comment. After the user has evaluated all five parts of the task, then according to step 36, depending on whether the user's evaluations in the known parts of the task match the evaluations for the known parts, the system will decide on further action. Namely, whether or not to permit the user to enter data into the system, and whether or not to accept the user's evaluation in the unknown parts of the task.

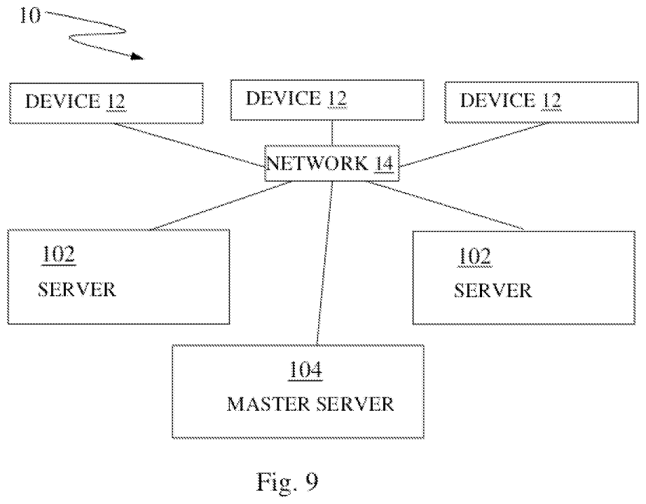

FIG. 9 illustrates a possible embodiment of system 10 in which more than one server 102 is present in network 14 and in which the separate steps of the moderation method are performed centrally, only, on a dedicated server, which is designated as master server 104. Various uses of the server 104 centrally performing the individual steps of the moderation method and combinations thereof are possible.

One possible use of the master server 104 is to centrally configure the system 10. In the case, the rules on which the information is verified, as well as the known information matching and not matching those rules, are no longer set on each server 102 individually, but are set and received centrally from the server 104. In this way, on the server 104 the administrator of the system fills in the tables 1, 3, 4, specifying rules and known information according to the stages 24,26,28. The servers 102 can receive copies of the information from tables 1, 3, 4 from the server 104 using standard database tools. As a result, the system 10 can implement uniform user input information requirements on all servers 102 of the network 14.

Another variant of using the master server 104 is also possible. In this embodiment, each of the servers 102 sends information needing evaluation from table 5 by standard means to server 104 in table 5, which contains information from the other servers as well. And in step 42, each of the servers 102 receives randomly selected, information for the unknown part of the task from server 104 from table 5. As a result, in the system 10 increases the rate of evaluation of information from the sparsely visited servers 102 and minimizes the likelihood that an individual ordinary user will get for evaluation information previously entered into the system by himself, since the information entered by that user can now be transmitted to another server 102 of the network 14 for evaluation.

1-12. (canceled)

13. A method for moderation of information by ordinary users, the method comprising creating a task for an ordinary user of a computer system, which contains at least one known part for which the system knows the answer and at least one unknown part for which the system does not know the answer; requesting that the user solve the known and unknown parts of the task; receiving answers from the user; determining that the user's answers in the known parts of the task match to the answers known to the system for the known parts of the task; identifying the user's answers in the unknown parts of the task as a solution for the unknown parts of the task if the user's answers in the known parts of the task match to answers that are known to the system for the known parts of the task; whereby the known and unknown parts of the task comprise a request to the user to evaluate the information for compliance with rules.

14. The method according to claim 13, whereby before a task is created for the user, the system administrator performs system configuration, which includes: creation of rules applied to the information; creation of known information that does not comply with the rules; creation of known information that complies with the rules.

15. The method according to claim 13, whereby the user is requested to perform the task before being permitted to enter information into the system.

16. The method according to claim 13, whereby to create a separate part of the task is performed: sampling of known information or sampling of unknown information, marked as needing to be evaluated for compliance with the rules; creating an offer to the user to evaluate this information.

17. The method according to claim 13, whereby the task includes at least one known part in which the rules are violated and at least one known part in which the rules are not violated.

18. The method according to claim 13, whereby the user is requested to evaluate the unknown and known parts of the task without informing the user which of the parts are the unknown parts of the task, and which of the parts are the known parts of the task.

19. The method according to claim 13, characterized in that the user is permitted to enter information into the system if the user's evaluation of at least one known part of the task matches to the evaluation that is known to the system for that known part of the task.

20. The method according to claim 13, whereby after the user is permitted to enter information into the system, information is received from the user and the information entered by the user is marked as needing to be evaluated for compliance with the rules.

21. The method according to claim 13, whereby the information needing evaluation may contain text, pictures, links, audio recordings, video recordings.

22. The method according to claim 13, whereby the user evaluation in the unknown part of the task is identified as a decision about compliance of the information from the unknown part of the task with the rules, if all user evaluations in the known parts of the task match to the evaluations, which are known to the system, for the known parts of the task.

23. The method according to claim 13, whereby after identifying the user evaluation in the unknown part of the task, as a decision about compliance with the rules, the information from the unknown part of the task is marked as evaluated information or the information from the unknown part of the task is marked as known information.

24. A system for moderation of information by ordinary users, which includes a network of multiple devices in which at least one of the devices is used by the ordinary user to input information into the system; at least one of the devices includes a processor and memory, characterized in that the memory contains machine-readable commands which, when executed by the processor, cause the processor to perform operations in accordance with claim 1.
